(19) United States
(12) Patent Application Publication
(10) Pub. No.: US 2026/0178508 A1
(43) Pub. Date: Jun. 25, 2026

(54) PAGE TABLE ENTRY OPTIMIZATION FOR MEMORY OPERATIONS

(71) Applicant: Advanced Micro Devices, Inc., Santa Clara, CA (US)

(72) Inventor: Madhusudan Ramaswamy Banavara, Andheri East (IN)

(21) Appl. No.: 18/987,798

(22) Filed: Dec. 19, 2024

(51) Int. Cl. G06F 12/1009; G06F 12/02; G06F 13/16

(52) U.S. Cl. CPC G06F 12/1009; G06F 12/0246; G06F 13/1668

(57) ABSTRACT

In an implementation, a computing device may include a processor having one or more cores. The computing device may also include a memory coupled to the processor, the memory having a page table. The computer device may further include where the processor is configured to receive a request to set a memory page to a fixed value, set, in a page table entry of the page table, a fixed page contents field to indicate the memory page contains the fixed value, and in response to a subsequent read request for the memory page, return the fixed value without accessing a physical page in the memory.

### BACKGROUND

Modern computing systems rely on efficient memory management to optimize performance and reduce power consumption. Virtual memory systems, which allow programs to use memory addresses that are mapped to physical memory locations by the operating system and hardware, have become ubiquitous in modern processors. These systems typically employ page tables to translate virtual addresses to physical addresses.

### BRIEF DESCRIPTION OF THE DRAWINGS

For a more complete understanding of the present disclosure, and the advantages thereof, reference is now made to the following descriptions taken in conjunction with the accompanying drawings.

FIG. 1 illustrates a block diagram of a computing device, in accordance with some implementations.

FIG. 2 illustrates a structure of a page table entry, in accordance with some implementations.

FIG. 3 illustrates a flowchart of a method for optimizing memory read operations, in accordance with some implementations.

FIG. 4 illustrates a flowchart of a method for optimizing memory write operations, in accordance with some implementations.

FIG. 5 illustrates an enhanced page table structure with additional fields, in accordance with some implementations.

FIG. 6 illustrates a flowchart of an optimized method for memory read operations, in accordance with some implementations.

FIG. 7 illustrates a flowchart of an optimized method for memory write operations, in accordance with some implementations.

FIG. 8 illustrates a flowchart of a method for setting and reading fixed-value memory pages, in accordance with some implementations.

FIG. 9 illustrates a flowchart of a method for managing memory pages with fixed content, in accordance with some implementations.

FIG. 10 illustrates a flowchart of a method for optimizing memory operations using modified page table entries, in accordance with some implementations.

Corresponding numerals and symbols in the different figures generally refer to corresponding parts unless otherwise indicated. The figures are drawn to clearly illustrate the relevant aspects of the implementations and are not necessarily drawn to scale. The edges of features drawn in the figures do not necessarily indicate the termination of the extent of the feature.

### DETAILED DESCRIPTION OF ILLUSTRATIVE IMPLEMENTATIONS

The making and using of various implementations are discussed in detail below. It should be appreciated, however, that the various implementations described herein are applicable in a wide variety of specific contexts. The specific implementations discussed are merely illustrative of specific ways to make and use various implementations, and should not be construed in a limited scope.

Reference to “an implementation,” “one implementation,” “an embodiment,” or “one embodiment” in the framework of the present description is intended to indicate that a particular configuration, structure, or characteristic described in relation to the implementation/embodiment is included in at least one implementation/embodiment. Hence, phrases such as “in one implementation” or “in one embodiment” that may be present in one or more points of the present description do not necessarily refer to one and the same implementation/embodiment. Moreover, particular conformations, structures, or characteristics may be combined in any adequate way in one or more implementations/embodiments. The references used herein are provided merely for convenience and hence do not define the extent of protection or the scope of the implementations/embodiments.

The rapid advancement of artificial intelligence and machine learning technologies has led to an unprecedented increase in computational demands. Industry analysis indicates that a rack of artificial intelligence servers can consume 30-100 kilowatts of power, compared to just 7 kilowatts for traditional servers. This dramatic increase in power consumption makes optimization of memory operations important for modern computing systems.

Operations that involve setting or reading large blocks of memory to known values, such as initializing buffers or clearing memory, are common in many applications and operating systems. This operation, may be implemented through functions like memset, ensures that memory contents are in a known state before use. Evidence of the prevalence of this operation can be seen in system page files and hibernation files-for example, a hiberfil.sys file that compresses from multiple gigabytes to just hundreds of megabytes, primarily because it contains mostly zeros.

The traditional approach to memory initialization involves writing the predetermined value to each memory location, followed by subsequent reads when the data is accessed. This process results in numerous unnecessary memory accesses, consuming valuable system resources and power. The challenge becomes particularly significant in artificial intelligence and high-performance computing applications, where memory initialization patterns are predictable but occur at massive scale.

To address these challenges, the present disclosure provides methods and systems for optimizing memory operations through enhanced page table entries. By introducing new fields in page table entries, computing systems may more efficiently manage memory pages containing fixed values, such as zeros or other predetermined patterns. This approach allows for reduced memory accesses, leading to improved performance and decreased power consumption.

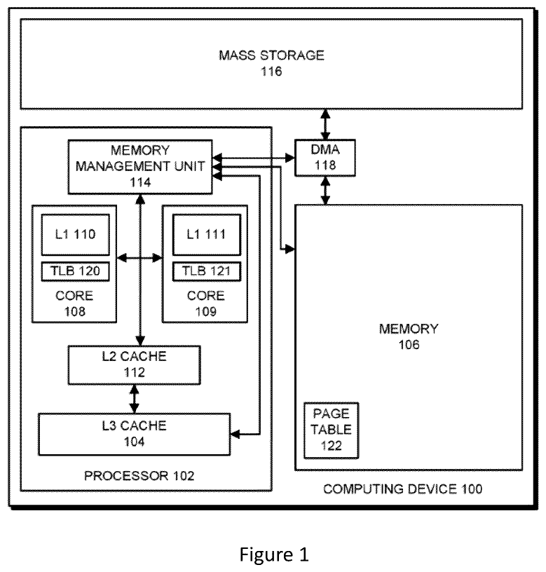

FIG. 1 illustrates a block diagram of a computing device 100 that implements enhanced memory optimization techniques through modified page table entries. The computing device 100 includes a processor 102, memory 106, mass storage 116, and a direct memory access (DMA) controller 118, all interconnected through communication paths that enable the transmission of data, commands, and control signals.

The processor 102 features a multi-core architecture and in the illustrated implementation includes two cores (108 and 109), though implementations may vary in the number of cores. Each core is equipped with dedicated resources to support memory operations: a level-one (L1) cache (110 and 111 respectively) and a translation lookaside buffer (TLB 120 and TLB 121). These components work together to optimize memory access patterns, particularly for the frequent memory initialization operations common in artificial intelligence and high-performance computing workloads.

The processor 102 implements a hierarchical cache structure designed to balance access speed with storage capacity. The L1 caches (110 and 111) represent the smallest but fastest tier, utilizing high-speed memory circuits such as static random access memory (SRAM). These caches are positioned closest to their respective cores, minimizing access latency for frequently used data and instructions. The next tier consists of a shared level-two (L2) cache 112, which offers larger capacity while maintaining reasonable access speeds. The hierarchy further includes a level-three (L3) cache 104, which serves as the last-level cache before accessing main memory, providing the largest cache capacity but with higher access latency.

The memory management unit (MMU) 114 coordinates the memory operations within the processor 102. It handles memory access requests from the cores and other functional blocks, managing the task of translating virtual addresses to physical addresses. This translation capability is utilized for the proposed memory optimization techniques, as it enables efficient handling of pages containing known values without requiring actual memory reads or writes.

The virtual memory system employs a two-tier approach to address translation. The primary mechanism is the page table 122, stored in memory 106, which maintains mappings between virtual and physical addresses for all active memory pages. In implementations of the present disclosure, this page table will be enhanced with new fields to support the optimization of memory operations, particularly for pages containing fixed values such as zeros. These enhancements enable the system to avoid unnecessary memory reads and writes while maintaining proper functionality.

Translation lookaside buffers (TLB 120 and TLB 121) form the second tier of the address translation system. Each core has its dedicated TLB that caches frequently used virtual-to-physical address translations, significantly reducing the need for time-consuming page table walks. These TLBs work in conjunction with the enhanced page table entries to provide rapid access to information about fixed-value pages, further improving system efficiency.

The memory 106 functions as the main memory of computing device 100, utilizing memory circuits such as dynamic random access memory (DRAM) or double data rate synchronous DRAM (DDR SDRAM), low power DDR, or the like. While offering greater capacity than the cache hierarchy, memory 106 has higher access latency. The proposed optimization techniques are particularly valuable in this context, as they can significantly reduce the number of actual memory accesses required for initialization operations.

The mass storage 116 provides non-volatile storage capacity for the computing device 100, implemented through technologies such as high-capacity semiconductor memory, flash storage, disk drives, or optical drives. This component is utilized in the memory management system, particularly during page swapping operations. When pages containing known fixed values need to be swapped in from mass storage, the enhanced page table entries can eliminate the need for actual data transfers, significantly reducing I/O overhead and power consumption.

The direct memory access (DMA) controller 118 facilitates efficient data movement between mass storage 116 and memory 106 without direct processor intervention. This capability is particularly valuable in the context of the proposed memory optimization techniques, as it allows the system to handle large-scale memory operations while freeing the processor cores for other computational tasks. The DMA controller can work in conjunction with the enhanced page table entries to optimize data transfer operations, especially when dealing with pages that contain known values.

All components within computing device 100 are interconnected through communication paths, shown as arrow-headed lines in the diagram. These paths enable the coordinated operation of the entire system, carrying commands, data, control signals, and status information between components.

The architecture is designed to be flexible and scalable. While FIG. 1 shows a specific configuration with two cores and three cache levels, the system can be implemented with various arrangements of cores, caches, and MMUs. For example, the cache hierarchy might include separate instruction and data caches, or additional cache levels. Similarly, the TLB configuration could be expanded to include separate data and instruction TLBs or implement a multi-level TLB hierarchy.

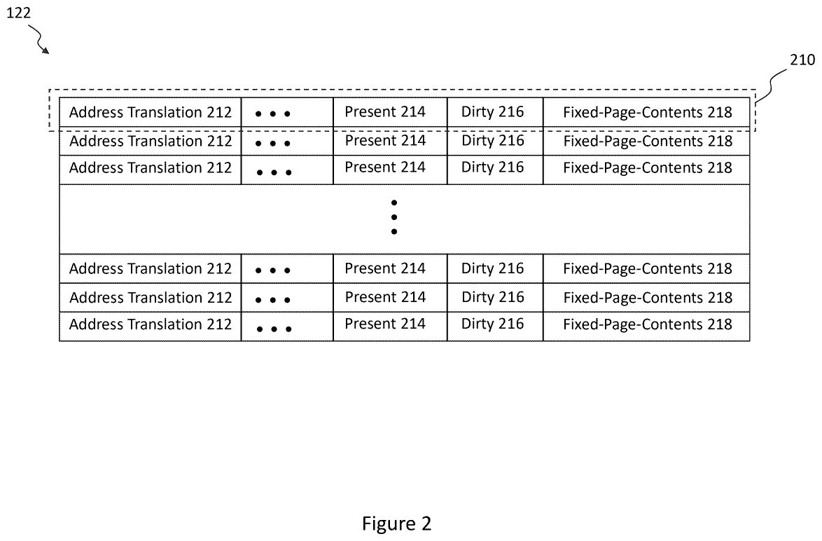

FIG. 2 illustrates a block diagram of a page table 122 structure for memory management according to some implementations. The page table 122 comprises multiple page table entries 210, each representing a page in memory.

Each page table entry 210 contains several fields. An address translation field 212 stores the physical address corresponding to the virtual address of the page. A present field 214 indicates whether the page is currently in physical memory. A dirty field 216 denotes whether the page has been modified since it was last loaded into memory.

In some implementations, a fixed page contents field 218 is added to each page table entry 210. This field indicates whether the page contains a fixed, known value. When this field is set, it signals that the entire page contains a predetermined value, eliminating the need for actual memory allocation and access operations.

The fixed page contents field 218 may be implemented as a single bit. When this bit is set, it signifies that the entire page contains a predetermined value, typically all zeros. This implementation is efficient as it doesn't require an additional field to store the actual predetermined value. By using just one bit to represent this information, the system can minimize the overhead added to each page table entry while still providing significant optimization potential.

The use of the fixed page contents field 218 allows the MMU 114 to make intelligent decisions about how to handle read and write operations for the corresponding memory page. For instance, when a read operation is requested for a page with the fixed page contents field 218 set, the MMU 114 can return the predetermined value (e.g., all zeros) without actually accessing the physical memory. This optimization can lead to reduced memory access times, decreased power consumption, and improved overall system performance.

Furthermore, this field can be particularly beneficial in scenarios where large portions of memory are frequently initialized to a known value, such as in the allocation of new memory blocks or the clearing of buffers. Instead of writing zeros to every byte of a newly allocated page, the system can simply set the fixed page contents field 218, effectively marking the entire page as containing zeros without performing any physical memory writes.

The MMU 114 is configured to receive requests to set memory pages to fixed values. In response to such requests, the MMU 114 updates the corresponding page table entries 210. This update involves setting the fixed page contents field 218 to indicate that the memory page contains the fixed value, and may also include modifying other fields in the page table entry.

For example, when setting the fixed page contents field 218, the MMU 114 may also set the present field 214 to indicate that the memory page is not present in physical memory. This operation allows for memory savings, as pages with known fixed contents may not require physical memory allocation until they are modified. Additionally, the MMU 114 may set the dirty field 216 to zero, indicating that the page's contents match its known state.

Although FIG. 2 only illustrates four fields in each page table entry 210, there may be many more fields in the page table entry 210.

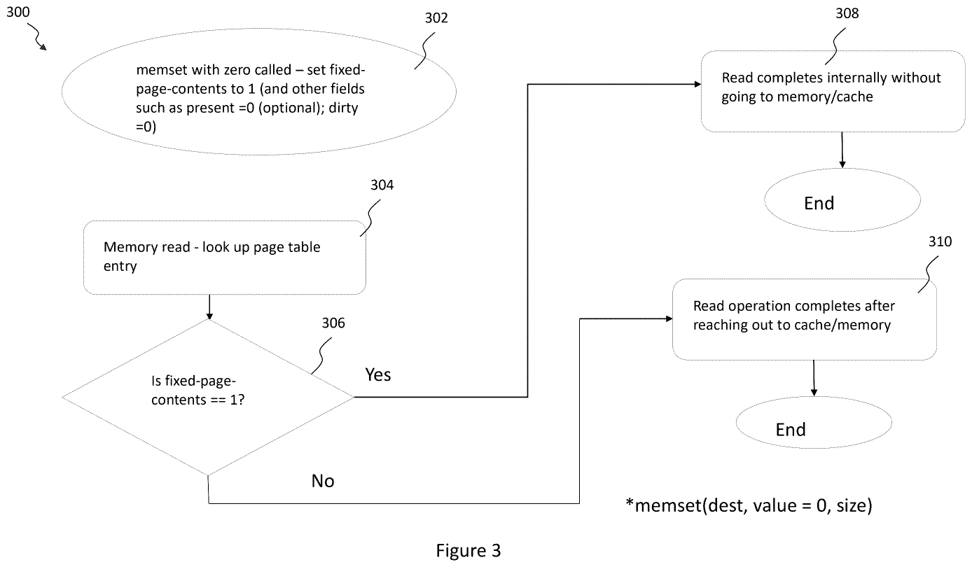

FIG. 3 illustrates a flowchart of a method 300 for a memory read process according to some implementations. In some implementations, the method 300 is performed by the MMU 114 to optimize memory operations, particularly for scenarios involving fixed-value memory pages.

The method 300 begins with step 302, where a memset operation with zero is called. In response to this operation, the MMU 114 sets the fixed-page-contents field 218 to 1 in the corresponding page table entry 210. Additionally, the MMU 114 modifies other fields in the page table entry 210, such as setting the present field 214 (optional setting) and dirty field 216 to 0. This step marks the memory page as containing a known fixed value (in this case, zero) without writing the value to physical memory.

Step 302 does not include a line or arrow leading to step 304. This is because step 302 may be performed at a time well before step 304. Step 302 is needed to set the fixed-page-contents field 218 so that subsequent reads and writes to the page for the respective page table entry 210 can utilize the optimization of the memory operations in the present implementation. In some implementations, there are many other steps or processes performed (potentially by other parts of the processor 102) or long periods of time passed between step 302 and the subsequent step 304. Said another way, step 302 may be considered a pre-condition or necessity for the other steps in the method 300.

In step 304, a memory read operation is initiated, triggering a look up of the page table entry 210. This step occurs when an application or system process requests data from the memory page that was previously set to the fixed value.

At step 306, the method 300 checks if the fixed-page-contents field 218 is equal to 1. This decision point determines the subsequent flow of the process and is part of the optimization of memory read operations.

If the fixed-page-contents field 218 is equal to 1 (Yes branch from step 306), the method 300 moves to step 308. In step 308, the read operation completes internally without accessing memory or cache. The MMU 114 returns the fixed value (in this case, zero) without the need to perform a physical memory access. This optimization improves efficiency and reduces power consumption by avoiding unnecessary memory transactions.

If the fixed-page-contents field 218 is not equal to 1 (No branch from step 306), the method 300 proceeds to step 310. In step 310, the read operation completes after reaching out to cache or memory. For example, the MMU 114 may first check the L1 cache 110 or 111 associated with the requesting core 108 or 109. If the data is not found in the L1 cache, the MMU 114 may then check the shared L2 cache 112. If the data is still not found, the MMU 114 may proceed to check the L3 cache 104. If the data is not present in any of the cache levels, the MMU 114 may then access the main memory 106 to retrieve the requested data. This memory access path may involve translating the virtual address to a physical address using the page table 122 and potentially updating the TLBs 120 and 121 for future accesses. This branch is taken when the memory page does not contain a known fixed value or has been modified since it was last set to a fixed value.

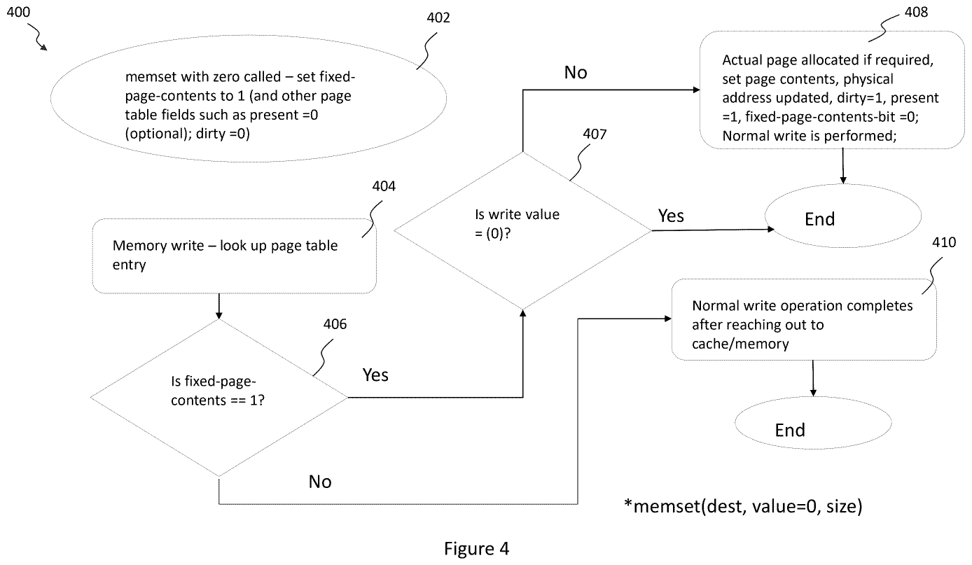

FIG. 4 illustrates a flowchart of a method 400 for a memory write process according to some implementations. In some implementations, the method 400 is performed by the MMU 114 to optimize memory operations, particularly for scenarios involving fixed-value memory pages.

The method 400 begins with step 402, where a memset operation with zero is called. In response to this operation, the MMU 114 sets the fixed-page-contents field 218 to 1 in the corresponding page table entry 210. Additionally, the MMU 114 modifies other page table fields such as setting the present field 214 to 0 (optional setting) and the dirty field 216 to 0. This step effectively marks the memory page as containing a known fixed value without necessarily writing the value to physical memory.

Similar to step 302 above, step 402 does not include a line or arrow leading to step 404. This is because step 402 may be performed at a time well before step 404. Step 402 is needed to set the fixed-page-contents field 218 so that subsequent reads and writes to the page for the respective page table entry 210 can utilize the optimization of the memory operations in the present implementation. In some implementations, there are many other steps or processes performed (potentially by other parts of the processor 102) or long periods of time passed between step 402 and the subsequent step 404. Said another way, step 402 may be considered a pre-condition or necessity for the other steps in the method 400.

In step 404, a memory write operation is initiated, triggering a look up of the corresponding page table entry 210. This step occurs when an application or system process attempts to write data to the memory page that was previously set to the fixed value.

At step 406, the method 400 checks if the fixed-page-contents field 218 is set to 1. This decision point determines the subsequent flow of the process and is part of the optimization of memory write operations.

If the fixed-page-contents field 218 is set to 1 (Yes branch from step 406), the method 400 proceeds to step 407—which checks if the write value is same as fixed value in the page (e.g., the value 0). If the write value is the same as the fixed value (Yes branch from step 407), no further operations are required. If the write value is not the same as the fixed value (No branch from step 407), the method proceeds to 408. If the No branch is taken it means that the memory page that the current page table entry 210 is referencing currently contains a fixed value, but is now being overwritten by a non-fixed value. Thus, in step 408, the MMU 114 performs several operations to prepare the memory page for writing. The MMU 114 begins by allocating an actual physical page, if required, for the memory page (as there may not have been an actual physical page for the fixed value), sets the page contents to the fixed value, then updates the physical address in the address translation field 212 of the page table entry 210. Following this, the MMU sets the dirty field 216 to 1 to indicate that the page has been modified, and sets the present field 214 to 1 to indicate that the memory page is now present in physical memory. Finally, the MMU resets the fixed-page-contents field 218 to 0 to indicate that the memory page no longer contains the fixed value.

After these updates, a normal write operation is performed to the newly allocated physical memory. This write operation may involve transferring the data from the processor 102's cache or registers to the physical memory location. The MMU 114 may coordinate with the cache hierarchy to ensure data coherency, potentially invalidating or updating any existing cache entries for the affected memory addresses. In some cases, the write operation may be buffered or combined with other pending writes to optimize memory bus utilization. The MMU 114 may also update any relevant metadata, such as access timestamps or reference counters, associated with the memory page. Once the write operation is complete, the MMU 114 may signal the completion to the requesting process or thread, allowing it to proceed with subsequent operations. This write process may help ensure that the memory contents are accurately updated while maintaining system consistency and performance.

If the fixed-page-contents field 218 is not set to 1 (No branch from step 406), the method 400 moves to step 410. In step 410, a normal write operation completes after reaching out to cache or memory. This branch is taken when the memory page does not contain a known fixed value or has already been modified since it was last set to a fixed value.

The implementation described in FIGS. 2 through 4 offers several advantages for memory management and operation optimization. The modified page table entry structure introduced in FIG. 2 includes a fixed page contents field, which allows the system to indicate when a memory page contains a predetermined value. This approach may reduce unnecessary memory accesses and potentially improve system efficiency.

FIG. 3 illustrates a method for optimizing memory read operations. By utilizing the fixed page contents field, the system may return predetermined values without accessing physical memory in certain cases. This approach may lead to faster read operations and reduced power consumption for pages with known content.

FIG. 4 demonstrates a method for optimizing memory write operations. When writing to a page with a set fixed page contents field, the system may perform several preparatory steps before the actual write operation. This process may help maintain data consistency while potentially improving write performance for pages transitioning from known to varied content.

Overall, these implementations may provide a balanced approach to memory management, potentially offering benefits in terms of operation speed, power efficiency, and system performance, particularly for applications involving frequent memory operations.

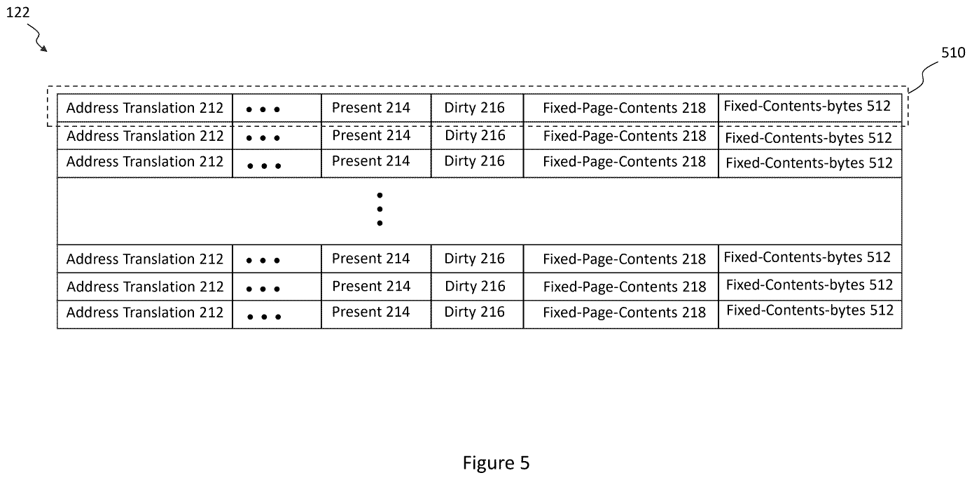

FIG. 5 illustrates a block diagram of an enhanced page table 122 structure for memory management according to some implementations. The enhanced structure builds upon the implementation in FIGS. 2 through 4 to support a wider range of optimization scenarios.

Each page table entry 510 contains the same base fields as the previous implementation (address translation 212, present 214, and dirty 216 fields). However, the current implementation introduces two new fields to enable more sophisticated memory optimization. First, the fixed page contents field 218 indicates whether the page contains a fixed, known value. Second, the fixed contents bytes field 512 stores the actual fixed value for the page when applicable.

This enhanced structure allows the system to optimize memory operations beyond simple zero-filling. The system supports various common initialization patterns used by applications. For instance, some applications use 0xA5 (binary 10100101) for creating alternating bit patterns useful in memory testing, while others might use 0xDEADBEEF for debugging and memory analysis. Beyond these common patterns, applications may require other predetermined patterns for security or application-specific purposes.

In some implementations, the fixed contents bytes field 512 is in a range from be 8 to 64 bits in size, providing flexibility to store different types of fixed values. In some implementations, the fixed contents bytes field 512 may be larger than 64 bits. This range allows the system to handle various initialization patterns while maintaining reasonable overhead in the page table structure.

By supporting a range of fixed values, the system can accommodate various application requirements and memory usage patterns. This flexibility is particularly valuable in scenarios where applications require specific initialization patterns for security, debugging, or testing purposes.

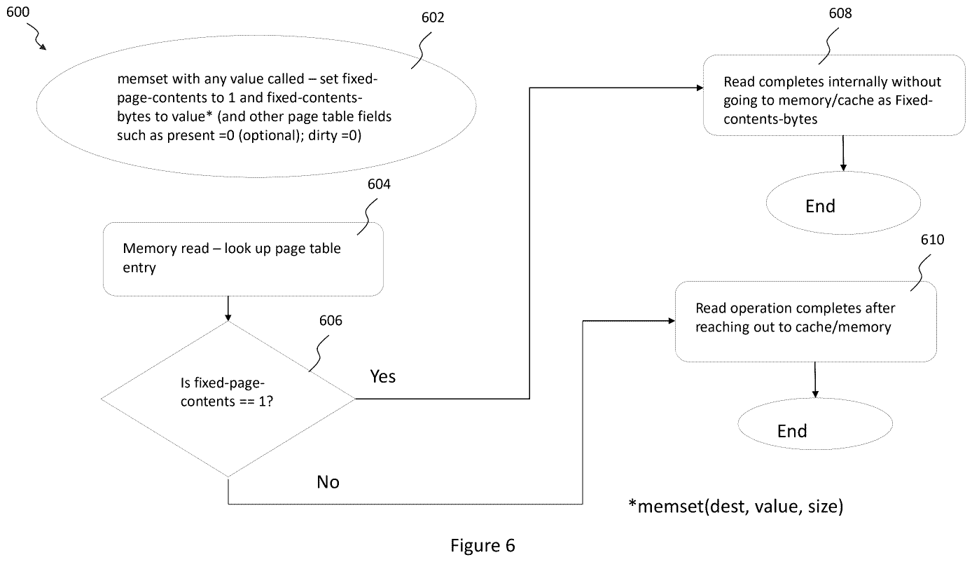

FIG. 6 illustrates a flowchart of a method 600 for a memory read process according to some implementations. The method 600 is performed by the MMU 114 to optimize memory operations, particularly for scenarios involving fixed-value memory pages with various patterns.

The method 600 begins with step 602, where a memset operation with a specified value is called. In response to this operation, the MMU 114 sets the fixed-page-contents field 218 to 1 in the corresponding page table entry 510 and stores the specified value in the fixed-contents-bytes field 512. Additionally, the MMU 114 modifies other fields in the page table entry 510, such as setting the present field 214 (optional setting) and dirty field 216 to 0. This step marks the memory page as containing a known fixed value without necessarily writing the value to physical memory.

Similar to steps 302 and 402 above, step 602 does not include a line or arrow leading to step 604 because step 602 may be performed at a time well before step 604. Step 602 may be considered a pre-condition or necessity for the other steps in the method 600.

In step 604, a memory read operation is initiated, triggering a look up of the corresponding page table entry 510. This step occurs when an application or system process requests data from the memory page that was previously set to the fixed value.

At step 606, the method 600 checks if the fixed-page-contents field 218 is equal to 1. This decision point determines the subsequent flow of the process and is part of the optimization of memory read operations.

If the fixed-page-contents field 218 is equal to 1 (Yes branch), the method 600 moves to step 608. In step 608, the read operation completes internally without accessing memory or cache. The MMU 114 returns the fixed value stored in the fixed-contents-bytes field 512 without the need to perform a physical memory access. This optimization improves efficiency and reduces power consumption by avoiding unnecessary memory transactions.

If the fixed-page-contents field 218 is not equal to 1 (No branch), the method 600 proceeds to step 610. In step 610, the read operation completes after reaching out to cache or memory, following a memory access path. An example of the memory access path was discussed above in FIG. 3 and the description is not repeated herein. This branch is taken when the memory page does not contain a known fixed value or has been modified since it was last set to a fixed value.

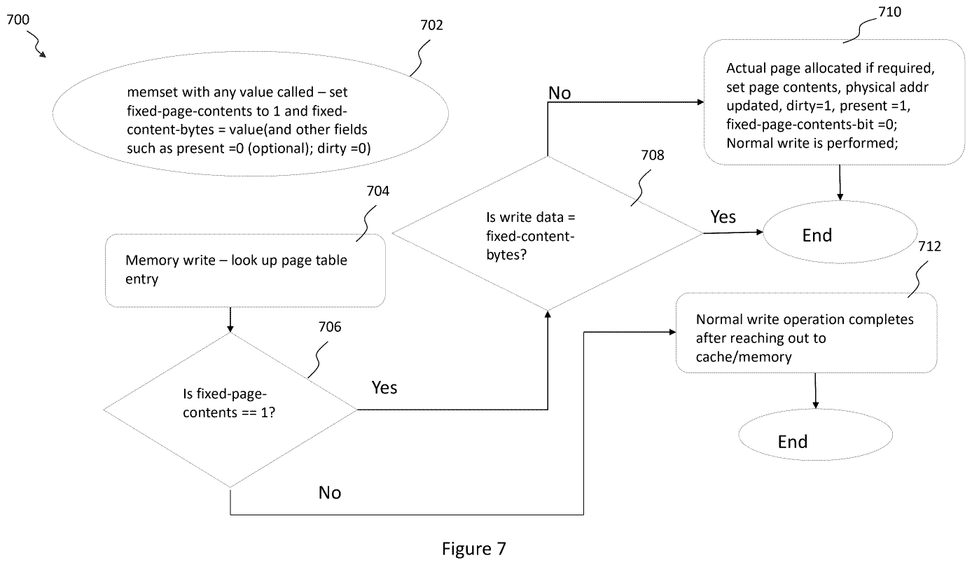

FIG. 7 illustrates a flowchart of a method 700 for an enhanced memory write process according to some implementations. This method extends the write optimization to handle pattern matching and partial page operations.

The method 700 begins with step 702, where a memset operation with a specified value is called. In response to this operation, the MMU 114 sets the fixed-page-contents field 218 to 1 in the corresponding page table entry 510. The MMU also stores the specified value in the fixed-contents-bytes field 512 and modifies other fields such as setting the present field 214 and dirty field 216 to 0.

Similar to steps 302, 402, and 602 above, step 702 does not include a line or arrow leading to step 704 because step 702 may be performed at a time well before step 704. Step 702 may be considered a pre-condition or necessity for the other steps in the method 700.

In step 704, a memory write operation is initiated, triggering a look up of the corresponding page table entry 510. This occurs when an application or system process attempts to write data to the memory page that was previously set to the fixed value.

At step 706, the method 700 checks if the fixed-page-contents field 218 is set to 1. If true (Yes branch from step 706), the method proceeds to step 708, where the MMU 114 determines if the write data matches the fixed-content-bytes stored in the fixed contents bytes field 512. This additional check enables further optimization when the write operation would not actually change the page contents.

If the write data matches the fixed-content-bytes (Yes branch from step 708), the method 700 ends without performing any additional operations. This optimization avoids unnecessary memory allocations and updates when the write operation would not change the page contents. In some implementations, step 708 is omitted and the Yes branch from step 706 goes to step 710 (see discussion below).

If the write data does not match the fixed-content-bytes (No branch from step 708), the process moves to step 710. If the No branch from step 708 is taken it means that the memory page that the current page table entry 510 is referencing currently contains a fixed value, but is now being overwritten by a non-fixed value. Thus, the MMU 114 performs the necessary operations to prepare the memory page for writing. The MMU 114 begins by allocating physical memory for the page if required, and sets contents to the fixed-content-bytes and updates the address translation field 212 with the physical address of the newly allocated memory. It then sets the dirty field 216 to 1 to indicate modification, sets the present field 214 to 1 to indicate the page is now present in physical memory, and resets the fixed-page-contents field 218 to 0. After these updates, a normal write operation is performed to the newly allocated physical memory. An example of the normal write operation was discussed above in FIG. 4 and the description is not repeated herein.

If the fixed-page-contents field 218 is not set to 1 (No branch from step 706), the method 700 proceeds directly to step 712. In this step, a normal write operation completes after reaching out to cache or memory. This branch is taken when the memory page does not contain a known fixed value or has already been modified since it was last set to a fixed value.

The implementation described in FIGS. 5 through 7 offer several advantages for memory management and operation optimization. FIG. 5 illustrates a page table structure that includes new fields: a fixed page contents field 218 and a fixed contents bytes field 512. These additions may allow the system to indicate when a page contains predetermined content and store that content directly in the page table entry.

FIG. 6 outlines a method for optimizing memory read operations using the enhanced page table structure. When a read operation is requested for a page with the fixed page contents field set, the system may return the value stored in the fixed contents bytes field without accessing physical memory. This approach may reduce unnecessary memory accesses for pages with known content.

FIG. 7 describes a method for optimizing memory write operations. When writing to a page with the fixed page contents field set, the system may compare the write data to the value in the fixed contents bytes field. If they match, the system may avoid allocating a physical page and performing the write operation. This may help reduce unnecessary memory allocations and write operations.

These implementations may provide a way to handle pages with known content more efficiently, potentially reducing memory accesses and improving system performance in certain scenarios.

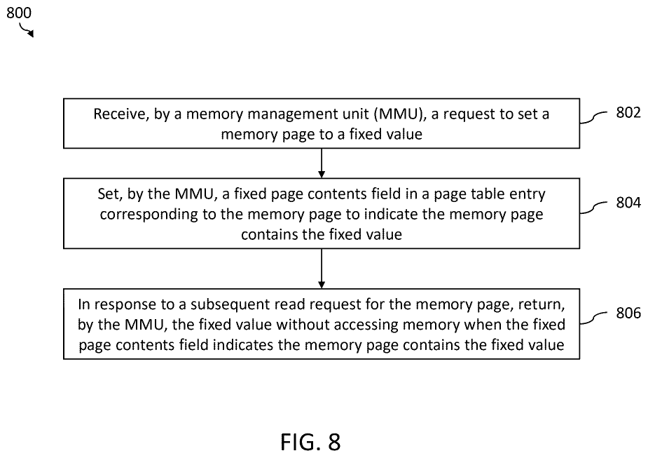

FIG. 8 illustrates a flowchart of a method 800 for optimizing memory operations using page table entry modifications. In step 802, an MMU receives a request to set a memory page to a fixed value. In some implementations, this step initiates the process of optimizing memory operations for pages with known content.

In step 804, the MMU sets a fixed page contents field in a page table entry corresponding to the memory page. This field indicates that the memory page contains the fixed value. By setting this field, the MMU creates a record of the page's known content without necessarily writing the value to the physical memory.

In step 806, the MMU responds to a subsequent read request for the memory page. When the fixed page contents field indicates that the memory page contains the fixed value, the MMU returns the fixed value without accessing the physical memory. This step demonstrates the optimization achieved by the method, as it eliminates the need for a memory access when the content is already known.

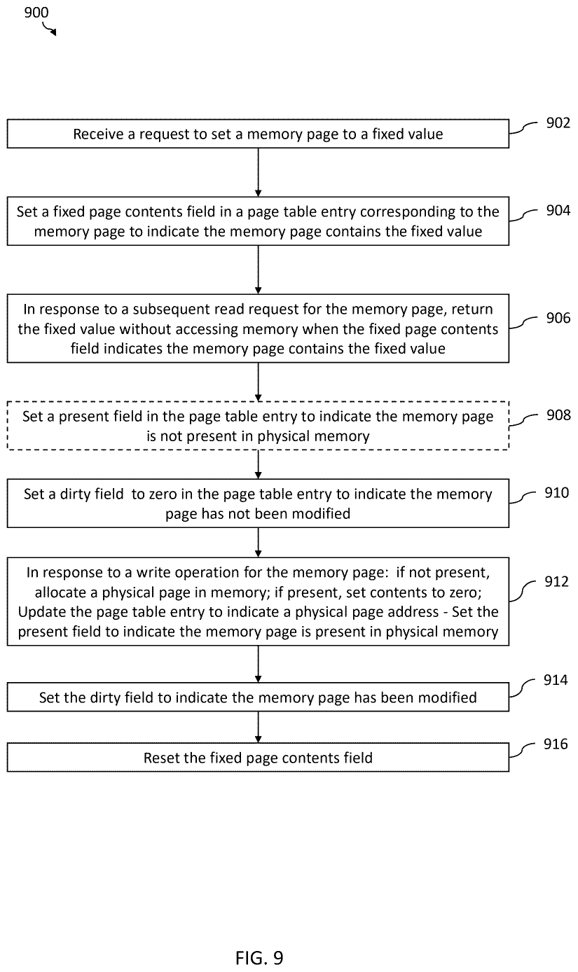

FIG. 9 illustrates a flowchart of a method 900 for optimizing memory operations using page table entry modifications. In step 902, a request to set a memory page to a fixed value is received.

In step 904, a fixed page contents field in a page table entry corresponding to the memory page is set to indicate the memory page contains the fixed value. Step 906 follows, where in response to a subsequent read request for the memory page, the fixed value is returned without accessing memory when the fixed page contents field indicates the memory page contains the fixed value.

In step 908, optionally a present field in the page table entry is set to zero to indicate the memory page is not present in physical memory. In step 910, a dirty field in the page table entry is set to indicate the memory page has not been modified.

Steps 912-920 involve responding to a write operation for the memory page in memory. In step 912, a physical page in memory is allocated (if required—i.e. if page was deallocated during memset)., the page table entry is then updated to indicate a physical page address., the present field is set to indicate the memory page is present in physical memory. In step 914, the dirty field is set to indicate the memory page has been modified. In step 916, the fixed page contents field is reset.

The method 900 demonstrates a process for managing memory pages with known fixed content, reducing unnecessary memory accesses and improving system performance through efficient use of page table entries.

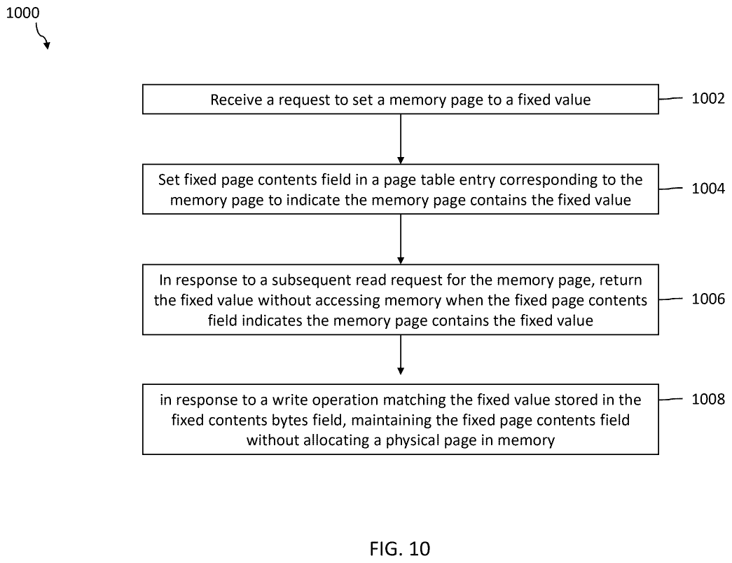

FIG. 10 illustrates a flowchart of a method 1000 for optimizing memory operations using page table entry modifications. In step 1002, a request is received to set a memory page to a fixed value. In some implementations, this step initiates the process of memory page optimization.

Following the initial request, the method 1000 proceeds to step 1004. In this step, a fixed page contents field is set in a page table entry corresponding to the memory page. This field indicates that the memory page contains the fixed value, allowing for optimizations in subsequent memory operations.

In step 1006, in response to a subsequent read request for the memory page, the method returns the fixed value without accessing memory, provided that the fixed page contents field indicates the memory page contains the fixed value. This step reduces unnecessary memory accesses and improves read operation efficiency.

Step 1008 addresses the handling of write operations. In response to a write operation that matches the fixed value stored in the fixed contents bytes field, the method maintains the fixed page contents field without allocating a physical page in memory. This step allows for further optimization by avoiding unnecessary memory allocation when the write operation does not change the page's contents.

The method 1000 demonstrates a process for optimizing memory operations through the use of modified page table entries. By leveraging the fixed page contents field and fixed contents bytes field, the method reduces memory accesses and improves overall system performance for certain memory operations.

The system may also implement optimizations for cache line operations when writing known values to entire pages or large blocks of memory. When the system is aware that a large block of memory is being set to a known value, the MMU 114 may skip reading the existing cache line from memory. Instead, it directly fills the cache line with the known value, reducing memory bus usage and speeding up the write process.

In some implementations, the MMU 114 is configured to handle cases where only a portion of a memory page is set to a fixed value. The page table entry 510 may be extended to include additional fields that define sections within the page that contain fixed values. When an application sets only a portion of a page to a known value, the MMU 114 can track these partial initializations and still benefit from the optimization techniques for the initialized portions.

The page table entry optimization technique described may be applicable to a wide range of computing devices and processing units. The method may be implemented in graphics processing units (GPUs) and neural processing units (NPUs) in addition to central processing units (CPUs). GPUs and NPUs often handle large amounts of data and may benefit from efficient memory management techniques. For GPUs, the optimization is particularly useful in scenarios involving texture mapping or frame buffer operations, where large portions of memory are initialized with specific patterns or values during rendering processes. Similarly, NPUs, which are specialized for machine learning and artificial intelligence tasks, may benefit from this optimization technique when initializing large arrays or matrices with specific values during neural network computations.

The optimization method also contributes to reducing wear on solid-state drives (SSDs) and other non-volatile storage devices. By avoiding unnecessary page swap operations for pages with known fixed contents, the system decreases the frequency of write operations to these storage devices. When page-files and hibernate files are smaller due to implementation of this idea, system recoveries from hibernation will be significantly faster. Furthermore, the actual hibernation process becomes more efficient as pages with known contents need not be written to disk.

The method may also lead to improvements in system recovery time, particularly when recovering from hibernation. Hibernate files, which store snapshots of system memory, may be significantly reduced in size when implementing this optimization. Since pages with known fixed contents can be represented by their page table entries rather than storing their actual contents, the resulting hibernate files may be more compact. This reduction in file size allows for faster system recovery when resuming from hibernation, enhancing the user experience and reducing downtime.

In some implementations, the MMU 114 may dynamically adjust its optimization strategies based on system workload and memory usage patterns. For example, the MMU 114 may modify its behavior based on the type of application workload. For artificial intelligence and machine learning applications, where memory initialization patterns are highly predictable and occur at massive scale, the MMU 114 may aggressively apply these optimizations. In contrast, for applications with more random memory access patterns, the MMU 114 may be more selective in applying the optimizations.

The page table entry optimization method may also interact with other memory management techniques, such as memory compression. The system may prioritize the application of fixed content optimizations over compression for pages that contain known values, reducing the computational overhead associated with compression and decompression operations. This interaction becomes particularly important in high-performance computing environments where both techniques might be employed to maximize system efficiency.

When handling cache operations for fixed-value pages, the system implements specific optimizations to reduce memory traffic. A typical write process would first read the existing cache line from memory if the data to be written doesn't fully occupy a cache line. However, with the proposed optimization, when writing known values for the entire page or large block, the system can skip reading the existing cache line from memory and instead directly fill the cache line with the known value. This optimization reduces memory bus usage by eliminating unnecessary read operations and speeds up the write process.

The implementation of this optimization technique may be detected through various methods. Inspection of disassembled code for memory operations like memset may reveal the use of this technique. For example, a typical memset operation may involve a loop of write instructions. However, if the optimization is implemented, the disassembled code may instead show operations that update page table entries rather than performing direct memory writes. Additionally, analysis of memory management routines specific to GPUs and NPUs may reveal the use of enhanced page table entries for optimizing fixed-value memory operations.

By implementing these optimizations across various types of processing units, computing systems may achieve more efficient memory management in a wide range of applications. This approach contributes to overall system performance improvements and power savings in diverse computing scenarios, from graphics rendering to machine learning computations.

The optimization becomes particularly valuable in modern computing environments where memory operations occur at massive scale. For artificial intelligence applications, where a single training session might involve millions of memory initializations, the cumulative effect of these optimizations can significantly reduce system power consumption and improve processing throughput. Similarly, in data center environments where thousands of servers operate continuously, the power savings from reduced memory operations can translate into substantial operational cost reductions.

Furthermore, the method provides benefits for system reliability and storage device longevity. By reducing the number of physical write operations to storage devices during page swapping and hibernation, the system can extend the lifespan of SSDs and other non-volatile storage devices. This becomes increasingly important in enterprise environments where storage device wear is a significant consideration for system maintenance and replacement schedules.

The optimization technique also provides advantages for real-time computing applications. By reducing the latency associated with memory initialization and access operations, the system can provide more predictable performance characteristics. This predictability is particularly valuable in scenarios where consistent response times are critical, such as in real-time data processing or interactive applications.

In an implementation, a computing device may include a processor having one or more cores. The computing device may also include a memory coupled to the processor, the memory having a page table. The computer device may further include where the processor is configured to receive a request to set a memory page to a fixed value, set, in a page table entry of the page table, a fixed page contents field to indicate the memory page contains the fixed value, and in response to a subsequent read request for the memory page, return the fixed value without accessing a physical page in the memory.

The described implementations may also include one or more of the following features. The computing device where the processor is further configured to set, in the page table entry of the page table, a present field to indicate the memory page is not present in physical memory, and set, in the page table entry of the page table, a dirty field to indicate the memory page has not been modified. The computing device where the processor is further configured to in response to a write operation for the memory page set contents of a physical page in the memory to a write value, update the page table entry in the page table to indicate a physical page address, set the present field in the page table entry to indicate the memory page is present in physical memory, set the dirty field in the page table entry to indicate the memory page has been modified, and reset the fixed page contents field in the page table entry. The computing device where the fixed value is zero. The computing device where the page table entry in the page table further may include a fixed contents bytes field to store the fixed value. The computing device where the processor is further configured to in response to the subsequent read request, return the fixed value stored in the fixed contents bytes field of the page table entry without accessing a physical page in the memory when the fixed page contents field in the page table entry indicates the memory page contains the fixed value. The computing device where the processor is further configured to in response to a write operation matching the fixed value stored in the fixed contents bytes field of the page table entry, maintain the fixed page contents field without allocating a physical page in the memory.

In an implementation, a method may include receiving, by a memory management unit (MMU), a request to set a memory page to a fixed value. The method may also include setting, by the MMU in a page table entry of a page table, a fixed page contents field to indicate the memory page contains the fixed value, and in response to a subsequent read request for the memory page, returning, by the MMU, the fixed value without accessing a physical page in memory.

The described implementations may also include one or more of the following features. The method may include setting, by the MMU in the page table entry of the page table, a present field to indicate the memory page is not present in physical memory, and setting, by the MMU in the page table entry of the page table, a dirty field to indicate the memory page has not been modified. The method may include in response to a write operation for the memory page setting, by the MMU, contents of a physical page in to a write value, updating, by the MMU, the page table entry in the page table to indicate a physical page address, setting, by the MMU, the present field in the page table entry to indicate the memory page is present in physical memory, setting, by the MMU, the dirty field in the page table entry to indicate the memory page has been modified, and resetting, by the MMU, the fixed page contents field in the page table entry. The method may include storing, by the MMU, the fixed value in a fixed contents bytes field in the page table entry, and where the fixed value may include a predetermined bit pattern. The method where returning the fixed value may include returning, by the MMU, the fixed value stored in the fixed contents bytes field of the page table entry without accessing a physical page in memory when the fixed page contents field in the page table entry indicates the memory page contains the fixed value. The method may include in response to a write operation matching the fixed value stored in the fixed contents bytes field of the page table entry, maintaining, by the MMU, the fixed page contents field without allocating a physical page in memory. The method where the fixed contents bytes field is in a range from 8 to 64 bits in size.

In an implementation, a non-transitory computer-readable medium storing instructions that, when executed by a processor, cause the processor to perform operations including configuring a memory management unit (MMU) to receive a request to set a memory page to a fixed value, set, in a page table entry of a page table, a fixed page contents field to indicate the memory page contains the fixed value, and in response to a subsequent read request for the memory page, return the fixed value without accessing a physical page in memory when the fixed page contents field in the page table entry indicates the memory page contains the fixed value.

The described implementations may also include one or more of the following features. The non-transitory computer-readable medium where the operations further may include configuring the MMU to set, in the page table entry of the page table, a present field to indicate the memory page is not present in physical memory, and set, in the page table entry of the page table, a dirty field to indicate the memory page has not been modified. The non-transitory computer readable medium where the operations further may include configuring the MMU to, in response to a write operation for the memory page set contents of a physical page in memory to a write, update the page table entry in the page table to indicate a physical page address, set the present field in the page table entry to indicate the memory page is present in physical memory, set the dirty field in the page table entry to indicate the memory page has been modified, and reset the fixed page contents field in the page table entry. The non-transitory computer readable medium where the operations further may include configuring the MMU to, when writing to a cache line of a page marked with the fixed page contents field in the page table entry skip reading of existing cache line contents from a physical page in memory, and directly fill the cache line with the fixed value. The non transitory computer-readable medium where the operations further may include configuring the MMU to store the fixed value in a fixed contents bytes field in the page table entry, and store range information in the page table entry indicating a portion of the memory page that contains the fixed value. The non-transitory computer-readable medium where the fixed value is one of a zero value or a predetermined test pattern value.

Although the description has been described in detail, it should be understood that various changes, substitutions, and alterations may be made without departing from the spirit and scope of this disclosure as defined by the appended claims. The same elements are designated with the same reference numbers in the various figures. Moreover, the scope of the disclosure is not intended to be limited to the particular implementations described herein, as one of ordinary skill in the art will readily appreciate from this disclosure that processes, machines, manufacture, compositions of matter, means, methods, or steps, presently existing or later to be developed, may perform substantially the same function or achieve substantially the same result as the corresponding implementations described herein. Accordingly, the appended claims are intended to include within their scope such processes, machines, manufacture, compositions of matter, means, methods, or steps.

What is claimed is:

1. A computing device, comprising:
a processor comprising one or more cores;
a memory coupled to the processor, the memory comprising a page table;
wherein the processor is configured to:
receive a request to set a memory page to a fixed value;
set, in a page table entry of the page table, a fixed page contents field to indicate the memory page contains the fixed value; and
in response to a subsequent read request for the memory page, return the fixed value without accessing a physical page in the memory.

2. The computing device of claim 1, wherein the processor is further configured to:
set, in the page table entry of the page table, a present field to indicate the memory page is not present in physical memory; and
set, in the page table entry of the page table, a dirty field to indicate the memory page has not been modified.

3. The computing device of claim 2, wherein the processor is further configured to:
in response to a write operation for the memory page:
set contents of a physical page in the memory to a write value;
update the page table entry in the page table to indicate a physical page address;
set the present field in the page table entry to indicate the memory page is present in physical memory;
set the dirty field in the page table entry to indicate the memory page has been modified; and
reset the fixed page contents field in the page table entry.

4. The computing device of claim 1, wherein the fixed value is zero.

5. The computing device of claim 1, wherein the page table entry in the page table further comprises a fixed contents bytes field to store the fixed value.

6. The computing device of claim 5, wherein the processor is further configured to:
in response to the subsequent read request, return the fixed value stored in the fixed contents bytes field of the page table entry without accessing a physical page in the memory when the fixed page contents field in the page table entry indicates the memory page contains the fixed value.

7. The computing device of claim 6, wherein the processor is further configured to:
in response to a write operation matching the fixed value stored in the fixed contents bytes field of the page table entry, maintain the fixed page contents field without allocating a physical page in the memory.

8. A method, comprising:
receiving, by a memory management unit (MMU), a request to set a memory page to a fixed value;
setting, by the MMU in a page table entry of a page table, a fixed page contents field to indicate the memory page contains the fixed value; and
in response to a subsequent read request for the memory page, returning, by the MMU, the fixed value without accessing a physical page in memory.

9. The method of claim 8, further comprising:
setting, by the MMU in the page table entry of the page table, a present field to indicate the memory page is not present in physical memory; and
setting, by the MMU in the page table entry of the page table, a dirty field to indicate the memory page has not been modified.

10. The method of claim 9, further comprising:
in response to a write operation for the memory page:
setting, by the MMU, contents of a physical page in to a write value;
updating, by the MMU, the page table entry in the page table to indicate a physical page address;
setting, by the MMU, the present field in the page table entry to indicate the memory page is present in physical memory;
setting, by the MMU, the dirty field in the page table entry to indicate the memory page has been modified; and
resetting, by the MMU, the fixed page contents field in the page table entry.

11. The method of claim 8, further comprising:
storing, by the MMU, the fixed value in a fixed contents bytes field in the page table entry; and
wherein the fixed value comprises a predetermined bit pattern.

12. The method of claim 11, wherein returning the fixed value comprises:
returning, by the MMU, the fixed value stored in the fixed contents bytes field of the page table entry without accessing a physical page in memory when the fixed page contents field in the page table entry indicates the memory page contains the fixed value.

13. The method of claim 11, further comprising:
in response to a write operation matching the fixed value stored in the fixed contents bytes field of the page table entry, maintaining, by the MMU, the fixed page contents field without allocating a physical page in memory.

14. The method of claim 11, wherein the fixed contents bytes field is in a range from 8 to 64 bits in size.

15. A non-transitory computer-readable medium storing instructions that, when executed by a processor, cause the processor to perform operations comprising:
configuring a memory management unit (MMU) to:
receive a request to set a memory page to a fixed value;
set, in a page table entry of a page table, a fixed page contents field to indicate the memory page contains the fixed value; and
in response to a subsequent read request for the memory page, return the fixed value without accessing a physical page in memory when the fixed page contents field in the page table entry indicates the memory page contains the fixed value.

16. The non-transitory computer-readable medium of claim 15, wherein the operations further comprise:
configuring the MMU to:
set, in the page table entry of the page table, a present field to indicate the memory page is not present in physical memory; and
set, in the page table entry of the page table, a dirty field to indicate the memory page has not been modified.

17. The non-transitory computer-readable medium of claim 16, wherein the operations further comprise:
configuring the MMU to, in response to a write operation for the memory page:
set contents of a physical page in memory to a write;
update the page table entry in the page table to indicate a physical page address;
set the present field in the page table entry to indicate the memory page is present in physical memory;
set the dirty field in the page table entry to indicate the memory page has been modified; and
reset the fixed page contents field in the page table entry.

18. The non-transitory computer-readable medium of claim 15, wherein the operations further comprise:
configuring the MMU to, when writing to a cache line of a page marked with the fixed page contents field in the page table entry:
skip reading of existing cache line contents from a physical page in memory; and
directly fill the cache line with the fixed value.

19. The non-transitory computer-readable medium of claim 15, wherein the operations further comprise:
configuring the MMU to:
store the fixed value in a fixed contents bytes field in the page table entry; and
store range information in the page table entry indicating a portion of the memory page that contains the fixed value.

20. The non-transitory computer-readable medium of claim 19, wherein the fixed value is one of a zero value or a predetermined test pattern value.
